(19) United States
(12) Patent Application Publication
(10) Pub. No.: US 2021/0189141 A1
(43) Pub. Date: Jun. 24, 2021

(54) INORGANIC PIGMENTS FOR USE IN LIQUID CRYSTAL DEVICES

(71) Applicant: Gauzy Ltd., Tel Aviv (IL)

(72) Inventors: Dana Gal-Fuss, Tel Aviv (IL); Tania Fadida, Holon (IL); Eyal Peso, Bat Yam (IL); Adrian Lofer, Kfar-Saba (IL)

(73) Assignee: Gauzy Ltd., Tel Aviv (IL)

(21) Appl. No.: 16/966,978

(22) PCT Filed: Jan. 31, 2019
(86) PCT No.: PCT/IL2019/050122

§ 371 Date: Aug. 3, 2020

Related U.S. Application Data
(60) Provisional application No. 62/624,812, filed on Feb. 1, 2018.

(51) Int. Cl. C09C 1/56; C09C 3/10; C09C 3/06; C09K 19/54

(52) U.S. Cl. CPC C09C 1/56; C09C 3/10; C09C 3/063; C09K 2019/521; C01P 2004/64; C01P 2006/40; C01P 2004/80; C09K 19/544

(57) ABSTRACT

A method of preparing non-conductive coated pigment particles for use in liquid crystal applications. A dispersion is prepared of a pigment such as carbon black in a solution comprising a first solvent and a surfactant. The dispersion is disrupted in order to separate agglomerates. A non-conductive coating material is added. In some embodiments of the invention, the non-conductive coating comprises a polymer soluble in the first solvent, and the coating is prepared by addition of a second solvent in which the polymer is insoluble. In other embodiments, the non-conductive coating comprises a metal oxide, and the coating is prepared by addition of a metal alkoxide that hydrolyzes to form the coating. The non-conductive pigment particles are then separated from the supernatant liquid, dried, and reduced to a powder. Liquid crystal devices comprising the particles typically have a haze of less than 7% and a total transmittance of >55%.

### REFERENCE TO RELATED PUBLICATIONS

This application claims priority from U.S. Provisional Pat. Appl. No. 62/624,812, filed 1 Feb. 2018.

### FIELD OF THE INVENTION

The present invention relates to inorganic pigments, and more specifically to methods of manufacture of inorganic pigments that are usable in liquid crystal devices.

### BACKGROUND OF THE INVENTION

Several attempts to create efficient dyes or pigments for use in liquid crystal (LC) displays have been made over the years. A pigment or dye must have certain characteristics in order to be usable and useful in liquid crystal devices, particularly switchable liquid crystal devices such as electronic shutters for windows. In particular, the dye or pigment must stable to UV radiation, and it must be refractive-index matched with the liquid crystal dispersion found in the device, e.g. a polymer-dispersed liquid crystal (PDLC) film. In addition, the dye particles must be non-conductive in order not to short-circuit the LC device.

More specifically, black pigments that enable a complete block of the visual field are desired in order to provide the best privacy liquid crystal devices, among other uses. One commonly used black pigment is carbon black, which comprises particles of carbon and is traditionally produced from charring organic materials such as wood or bone. Commercially available carbon black is generally unsuitable for use in LC display devices, however. Since carbon is a conductive material, introduction of carbon black into an LC device generally leads to problems with short-circuiting. In addition, incorporation of off-the-shelf carbon black into an LC device generally produces a product with far too much haze (typically 30-40%) to be useful.

Japanese patent publication JP2009237466 discloses a carbon black dispersed liquid and a black photosensitive composition, improving stability of a dispersed liquid of a carbon black pigment and obtaining satisfactory sensitivity, suitable pattern shape and a fine pattern; a color filter using it, which has a black matrix with high light shielding performance; and a liquid crystal display device including the color filter. The carbon black dispersed liquid at least including (A) a carbon black pigment, (B) high polymer dispersants, and (C) a solvent, one of the (B) high polymer dispersants is a compound having an unsaturated double-bond and an urethane bond. This black photosensitive composition uses the above dispersed liquid. This color filter has a black matrix with high light shielding performance. This liquid crystal display device includes the color filter.

Japanese Pat. No. 3515855 discloses a composition for a liquid crystal panel. More specifically, the present invention relates to a composition for a liquid crystal panel which has a large hiding power and is excellent in insulation properties, which can be suitably used, for example, for forming a black matrix in a liquid crystal panel.

U.S. Pat. No. 8,026,319 discloses a dispersible surface-modified carbon black that is surface-modified by causing a functional group on the surface of the carbon black to be bonded to a diol-modified end-containing polymer through a triisocyanate compound which exhibits excellent dispersibility in a non-polar solvent, a low-polar solvent, and a resin. The dispersible surface-modified carbon black is characterized in that a surface functional group of the carbon black is bonded to one isocyanate end group of a triisocyanate compound having three isocyanate end groups, and the remaining two isocyanate end groups are respectively bonded to hydroxyl groups of a diol-modified end-containing polymer.

U.S. Pat. No. 4,805,995 discloses a liquid crystal display device which comprises a black mask layer formed by ink wherein particles of carbon have a diameter ranging from about 0.1 to about 0.3 microns. The carbon particle size is effective to inhibit carbon particles from aggregating themselves into a projection which may establish electric connection between a common electrode and a segment electrode of the liquid crystal display device. This improves the reliability of the liquid crystal display device and the yield upon production of liquid crystal display devices.

U.S. Pat. No. 8,749,738 discloses a liquid crystal panel and a manufacturing method thereof, and a liquid crystal display; the manufacturing method of the liquid crystal panel comprises the following steps: conducting materials are mixed into black matrix coating materials and black matrix deposition is conducted. In the present invention, because the conducting materials are mixed into the black matrix coating materials, the black matrix can conduct electricity and therefore, the liquid crystal panel can conduct static electricity by the conductivity of the black matrix to protect the liquid crystal panel and assemblies on the liquid crystal panel; the reliability of the liquid crystal panel is increased, because of the conductivity of the black matrix, the liquid crystal panel does not need additional conducting design (i.e. a layer of electrodes does not need to be deposited on the color film substrate of the liquid crystal panel), a deposition technology is omitted, production efficiency is increased and the production cost of the liquid crystal panel is economized.

U.S. Pat. No. 5,448,382 discloses an apparatus and method for viewing a scene where a portion of the field of view may exhibit excessive brightness, comprising a nonlinear optical scattering screen for which the scattering coefficient of the screen decreases rapidly with increasing light intensity above a threshold intensity. The scene is viewed by imaging light from the scene onto the nonlinear scattering screen and then reimaging the light scattered by the screen onto human retinas or other light detectors. Where an absorber material such as carbon black, or one or more dye(s) having selective absorption bands, or a reversible-bleachable thermochromic or reversible photochromic-thermally-bleachable absorber such as spiropyran is dispersed in the scattering layer.

U.S. Pat. No. 5,481,385 discloses a direct view display including a light generating means for generating light, a modulating means for modulating light from said light generating means to form an image, and an image display means for displaying said image from said modulating means positioned adjacent to the light output surface of said modulating means, said display means comprising an array of tapered optical waveguides on a planar substrate the tapered end of each of said waveguides extending outward from said substrate and having a light input surface adjacent said substrate and a light output surface distal from said light input surface. The area of the light input surface of each waveguide is greater than the area of its light output surface, and the center-to-center distance between the light input surfaces of adjacent waveguides in said array is equal to the center-to-center distance between the light output surfaces thereof, so that the angular distribution of light emerging from the output surfaces of the waveguides is larger than the angular distribution of light entering the waveguides. Also, the waveguides in said array are separated by interstitial regions with a lower refractive index than the refractive index of said waveguides.

U.S. Pat. No. 9,057,020 discloses a black dichroic dye composition comprising 2 or more dyes, one red or yellow and the other blue. The dye composition is well suited for combination with liquid crystal material for use, inter alia, as polarizing film and/or in liquid crystal displays, showing, inter alia, high dichroic ratio and excellent compatibility with the LC material.

U.S. Pat. No. 9,575,230 discloses a color filter comprising a cured layer of a photosensitive resist composition comprising a highly reactive polyacrylate monomer and a process for the preparation thereof are provided. The color filter is especially useful for low temperature applications such as electrophoretic displays, polymer dispersed liquid crystal displays, OLED devices and the like. Further, as a black pigment for black matrices, carbon black, titanium black, aniline black, an anthraquinone black pigment, a perylene black pigment, specifically, C.I. Pigment Black 1, 6, 7, 12, 20, 27, 30, 31 or 32 can be used. Among these, carbon black is preferred. The surface of carbon black may be treated with, e.g., a resin. The surface of each of these pigments may be modified with a polymer before use. The polymer for modifying the surface of the pigment may be a polymer, a commercial polymer or oligomer for dispersing a pigment, or the like.

It is thus clear from the above that an improved liquid crystal device that incorporates inorganic pigments as well as an improved method for preparing the pigments to be used in the device remains a long-felt, but as yet unmet need.

### SUMMARY OF THE INVENTION

It is therefore an object of this invention to disclose a method for producing a coated pigment suitable for use in a liquid crystal device, wherein said method comprises:
preparing a first solution comprising a surfactant in a first solvent;
adding a coating precursor to said first solution;
adding a pigment comprising particles to said first solution;
mixing said pigment and said solution until a suspension or dispersion of said pigment in said first solution is obtained;
disrupting said suspension or dispersion, thereby separating agglomerates of said pigment into particles and producing a dispersion of said particles of pigment;
adding a second solvent miscible with said first solvent to said dispersion, thereby causing the deposition of a coating of material derived from said coating precursor onto a surface of at least a portion of said particles and producing coated particles;
separating at least a portion of said coated particles from said dispersion; and,
reducing said coated particles separated from said dispersion to a powder.

It is a further object of this invention to disclose such a method, wherein said step of disrupting said suspension or dispersion comprises disrupting said suspension or dispersion by a method selected from the group consisting of sonication, ball milling, bead beating, and homogenization.

It is a further object of this invention to disclose the method as defined in any of the above, wherein said step of separating said coated particles from said dispersion comprises centrifuging said dispersion.

It is a further object of this invention to disclose the method as defined in any of the above, wherein said step of separating said coated particles from said suspension is followed by: separating coated particles above a predetermined size from said coated particles; discarding said coated particles above a predetermined size; and, retaining coated particles at or below said predetermined size. In some preferred embodiments of the invention, said step of separating at least a portion of said coated particles from said dispersion comprises separating at least a portion of said coated particles from said dispersion to yield coated particles characterized by a diameter of ≤100 nm as measured by dynamic light scattering.

It is a further object of this invention to disclose the method as defined in any of the above, wherein said step of separating at least a portion of said coated particles is followed by a step of washing said coated particles separated from said suspension. In some preferred embodiments of the invention, said step of washing comprises washing with said second solvent.

It is a further object of this invention to disclose the method as defined in any of the above, wherein said step of separating at least a portion of said coated particles from said suspension is followed by drying said coated particles separated from said suspension.

It is a further object of this invention to disclose the method as defined in any of the above, wherein said step of adding a coating precursor comprises adding a polymer that is less soluble in said second solvent than it is in said first solvent. In some preferred embodiments of the invention, said polymer is insoluble in said second solvent.

In some preferred embodiments of the method, said first solvent and said second solvent are selected from the group consisting of hexane, benzene, toluene, diethyl ether, chloroform, 1,4-Dioxane, ethyl acetate, tetrahydrofuran, dichloromethane, acetone, acetonitrile, dimethylformamide, dimethyl sulfoxide, acetic acid, n-butanol, isopropanol, n-propanol, ethanol, methanol, formic acid, and water. In some particularly preferred embodiments of the method, said first solvent is water. In some particularly preferred embodiments of the method, said first solvent is water and said second solvent is acetone.

In some preferred embodiments of the method in which said coating precursor is a polymer, said polymer comprises a hydrophobic chain and hydrophilic side groups. In some particularly preferred embodiments, said polymer comprises at least one polymer selected from the group consisting of poly(ethylene glycol) (PEG), polyvinylpyrrolidone (PVP), polyvinyl alcohol (PVA), polyacrylic acid (PAA), polyacrylamide, N-(2-hydroxypropyl)methacrylamide (HPMA), divinyl ether-maleic anhydride (DIVEMA), polyoxazoline, polyphosphoester (PPE), polyphosphazene, Xanthan Gum, pectin, chitosan derivatives, dextran, carrageenan, guar gum, cellulose ether, hyaluronic acid (HA), and siloxane. In some especially preferred embodiments, said polymer is polyvinylpyrrolidine. In some preferred embodiments, said polymer is characterized by a molecular weight of between 10 kD and 1300 kD.

In some preferred embodiments of the method in which said coating precursor is a polymer, said polymer is soluble in, and selected to match a refractive index of, a predetermined liquid crystal material.

In some preferred embodiments of the method in which said coating precursor is a polymer, said steps of preparing a first solution comprising a surfactant in a first solvent and adding a coating precursor to said first solution are performed by preparing a first solution comprising a surfactant and a polymer; and, said step of adding a pigment comprises adding a pigment to said first solution comprising said surfactant and said polymer.

In some preferred embodiments of the method in which said coating precursor is a polymer, wherein said steps of preparing a first solution comprising a surfactant in a first solvent; adding a coating precursor to said first solution; and adding a pigment comprising particles to said first solution are performed by mixing a first solvent, a surfactant, a polymer, and a pigment comprising particles, until said surfactant and said polymer dissolve and a suspension or dispersion of said pigment is formed.

In some embodiments of the method in which said coating precursor is a polymer, said steps of preparing a solution comprising a surfactant in a first solvent; adding a coating precursor to said solution; and adding a pigment comprising particles to said solution are performed substantially simultaneously.

It is a further object of this embodiment to disclose the method as defined in any of the above, wherein said step of adding a coating precursor comprises adding a sol-gel reagent that upon hydrolysis will yield a non-conductive oxide; and said method comprises adding a reagent that will initiate hydrolysis of said sol-gel reagent.

In some embodiments of the method in which said step of adding a coating precursor comprises adding a sol-gel reagent that upon hydrolysis will yield a non-conductive oxide, said step of adding pigment precedes said step of adding a coating precursor. In some embodiments of the method in which said step of adding a coating precursor comprises adding a sol-gel reagent that upon hydrolysis will yield a non-conductive oxide, said steps of adding pigment and disrupting said suspension or dispersion precede said step of adding a coating precursor.

In some embodiments in which said step of adding a coating precursor comprises adding a sol-gel reagent that upon hydrolysis will yield a non-conductive oxide, said sol-gel reagent is an alkoxide. In some preferred embodiments of the method, said alkoxide is selected from the group consisting of tetraethoxysilane, titanium tetraisopropoxide, titanium tetrabutoxide, titanium ethoxide, and zirconium propoxide.

In some embodiments of the method in which said step of adding a coating precursor comprises adding a sol-gel reagent that upon hydrolysis will yield a non-conductive oxide, said reagent that will initiate hydrolysis of said sol-gel reagent is a base. In some preferred embodiments of the invention, said base ammonium hydroxide.

In some embodiments of the method in which said step of adding a coating precursor comprises adding a sol-gel reagent that upon hydrolysis will yield a non-conductive oxide, said steps of adding a second solvent and adding a reagent that will initiate hydrolysis of said sol-gel reagent are performed by: preparing a second solution comprising said reagent that will initiate hydrolysis of said sol-gel reagent in said second solvent; and, adding said second solution to said first solution. In some preferred embodiments of the invention, said steps of preparing a second solution and adding said second solution to said first solution precede said step of adding pigment.

In some embodiments of the method in which said step of adding a coating precursor comprises adding a sol-gel reagent that upon hydrolysis will yield a non-conductive oxide and said steps of adding pigment and disrupting said suspension or dispersion precede said step of adding a coating precursor, said steps of adding a second solvent and adding a reagent that will initiate hydrolysis of said sol-gel reagent are performed by: preparing a second solution comprising said reagent that will initiate hydrolysis of said sol-gel reagent in said second solvent; and, adding said second solution to said dispersion. In some preferred embodiments of the method, said steps of preparing a second solution and adding said second solution to said first solution precede said step of adding pigment.

It is a further object of this embodiment to disclose the method as defined in any of the above, wherein said step of adding particles of a pigment comprises adding particles of a conductive pigment.

It is a further object of this embodiment to disclose the method as defined in any of the above, wherein said step of adding particles of a pigment comprises adding particles of at least one pigment selected from the group consisting of carbon black, silver, boron carbide, titanium nitride, zirconium carbide, zirconium boride, tungsten carbide, and tungsten disulfide. In some preferred embodiments of the method, said step of adding particles of a pigment comprises adding particles of carbon black.

It is a further object of this invention to disclose coated pigment particles prepared according the method as defined in any of the above. In some preferred embodiments of the invention, said particles are characterized by a mean diameter of ≤100 nm, as measured by dynamic light scattering.

It is a further object of this invention to disclose the use of nanoparticulate pigment particles coated with a non-conductive coating in a liquid crystal device. In some preferred embodiments of the invention, said nanoparticulate polymer-coated pigment particles comprise nanoparticulate particles of carbon black coated with a non-conductive polymer. In some particularly preferred embodiments of the invention, said non-conductive polymer is PVP. In some embodiments of the invention, said nanoparticulate polymer-coated pigment particles comprise nanoparticulate particles of carbon black coated with a non-conductive oxide. In some embodiments of the invention, said device comprises a liquid crystal composition, and said nanoparticulate polymer-coated pigment particles are incorporated into said liquid crystal composition. In some embodiments of the invention, said liquid crystal composition is a polymer dispersed liquid crystal (PDLC) composition.

It is a further object of this invention to disclose the use of nanoparticulate pigment particles coated with a non-conductive coating in a liquid crystal device as defined in any of the above, wherein said pigment particles are prepared according to the method as defined in any of the above.

It is a further object of this invention to disclose a method for making a polymer dispersed liquid crystal (PDLC) composition comprising polymer-coated pigment particles, comprising: preparing a homogeneous mixture comprising prepolymer, a liquid crystal, and coated pigment particles prepared according to the method as defined in any of the above; and, polymerizing said prepolymer to yield said PDLC composition. In some preferred embodiments of the method, said coated pigment particles comprise carbon black. In some particularly preferred embodiments of the invention, said coated pigment particles comprise carbon black coated with PVP. In some particularly preferred embodiments of the method, wherein said coated pigment particles comprise carbon black coated with a non-conductive metal oxide.

It is a further object of this invention to disclose the method for making a polymer dispersed liquid crystal (PDLC) composition comprising polymer-coated pigment particles as defined in any of the above, wherein said step of preparing a homogeneous mixture comprises preparing a homogeneous mixture comprising between 0.3% and 1% by weight of polymer-coated pigment particles.

It is a further object of this invention to disclose the method for making a polymer dispersed liquid crystal (PDLC) composition comprising polymer-coated pigment particles as defined in any of the above, wherein said PDLC composition comprises a PDLC layer characterized by a thickness of between 15 μm and 30 μm.

It is a further object of this invention to disclose the method for making a polymer dispersed liquid crystal (PDLC) composition comprising polymer-coated pigment particles as defined in any of the above, wherein said polymer-coated pigment particles are characterized by a conductance sufficiently small so as to yield a PDLC composition characterized by a conductance of no greater than 10⁻¹² (ohm-cm)².

It is a further object of this invention to disclose a PDLC composition prepared according to the method as defined in any of the above.

It is a further object of this invention to disclose the use of the PDLC composition as defined in any of the above in a liquid crystal device.

It is a scope of the present invention to provide a method of manufacture of dyes usable in liquid crystal applications comprising the steps of: admixing at least one dye, at least one surfactant and at least one polymer to a first suitable solvent, thereby creating a solution; mixing said solution; disrupting said solution; adding a second suitable solvent to said solution; centrifuging said solution, thereby creating a precipitate; washing said precipitate at least once; drying said precipitate, thereby creating a solid precipitate; pulverizing said solid precipitate, thereby creating a dye usable in liquid crystal applications; wherein said polymer neutralizes the conductive properties of said dye thereby providing an usable dye for liquid crystal applications; wherein said step of pulverizing provides particles that increment the haze in said liquid crystal up to 7%.

It is further a scope of the present invention to provide a method of manufacture of dyes usable in liquid crystal applications comprising the steps of: adding at least one conductive pigment, at least one surfactant and at least one polymer to a first suitable solvent, thereby creating a solution; mixing said solution; disrupting said solution; filtering said solution; resuspending using a second suitable solvent and a base; adding a reagent to said solution; centrifuging said solution, thereby creating a precipitate; washing said precipitate at least once; drying said precipitate, thereby creating a solid precipitate; pulverizing said solid precipitate, thereby creating a dye usable in liquid crystal applications; wherein said polymer by means of said reagent neutralizes the conductive properties of said pigment thereby providing an usable dye for liquid crystal applications; wherein said step of pulverizing provides particles which, when incorporated into a liquid crystal device in a concentration of 0.5% by weight, produce a device characterized by haze of ≤7%.

It is further a scope of the present invention to provide any of the methods above, where said first and said second suitable solvent are selected from the group consisting of: hexane, benzene, toluene, diethyl ether, chloroform, 1,4-dioxane, ethyl acetate, tetrahydrofuran (THF), dichloromethane, acetone, acetonitrile (MeCN), dimethylformamide (DMF), dimethyl sulfoxide (DMSO), acetic acid, n-Butanol, isopropanol, n-propanol, ethanol, methanol, formic acid, water, and any combination thereof.

It is further a scope of the present invention to provide any of the methods above, where said first solvent actuates as solvent in the solution and said second solvent acts as antisolvent in said solution.

It is further a scope of the present invention to provide any of the methods above, where said dye is selected from the group consisting of: organic, inorganic, natural, synthetic, and any combination thereof.

It is further a scope of the present invention to provide any of the methods above, where said organic dyes are selected from the group consisting of: Alizarin, Anthoxanthin, Arylide yellow, Azo compound, Bilin (biochemistry), Bistre, Bone char, Caput mortuum, Carmine, Crimson, Diarylide pigment, Dibromoanthanthrone, Dragon's blood, Gamboge, Indian yellow, Indigo dye, Naphthol AS, Naphthol Red, Ommochrome, Perinone, Phthalocyanine Blue BN, Phthalocyanine Green G, Pigment violet 23, Pigment Yellow 10, Pigment Yellow 16, Pigment Yellow 81, Pigment yellow 83, Pigment yellow 139, Pigment yellow 185, Quinacridone, Rose madder, Rylene dye, Sepia (color), Tyrian purple, and any combination thereof.

It is further a scope of the present invention to provide any of the methods above, where said inorganic dyes are selected from the group consisting of: Ultramarine violet: (PV15) Silicate of sodium and aluminum containing sulfur, Han Purple: BaCuSi₂O₆, Cobalt Violet: (PV14) cobaltous orthophosphate, Manganese violet: NH₄MnP₂O₇ (PV16) Manganic ammonium pyrophosphate, Ultramarine (Na₈₋₁₀Al₆Si₆O₂₄S₂₋₄), Persian blue, (Na,Ca)₈(AlSiO₄)₆(S,SO₄,Cl)₁₋₂, Cobalt Blue (PB28), Cerulean Blue (PB35), Egyptian Blue (CaCuSi₄O₁₀), Han Blue: BaCuSi₄O₁₀, cupric carbonate hydroxide (Cu₃(CO₃)₂(OH)₂), Prussian Blue (PB27) (Fe7(CN)18), YInMn Blue (YIn₁₋ₓMnₓO₃), Cadmium Green, Chrome green (PG17 (Cr₂O₃), Viridian (PG18) (Cr₂O₃.H₂O), Cobalt green (CoZnO₂), Malachite (Cu₂CO₃(OH)₂), Paris Green (Cu(C₂H₃O₂)₂.3Cu(AsO₂)₂), Scheele's Green (CuHAsO₃), Verdigris (Cu(CH₃CO₂)₂), malachite (Cu₂CO₃(OH)₂), Green earth (K[Al,Fe^{III}),(Fe^{II},Mg](AlSi₃,Si₄)O₁₀(OH)₂), Orpiment (As₂S₃), Cadmium Yellow (PY37), Chrome Yellow (PY34) (PbCrO4), Aureolin (PY40): Potassium cobaltinitrite (K₃Co(NO₂)₆), Yellow Ochre (PY43) (Fe₂O₃.H₂O), Naples Yellow (PY41), Lead-tin-yellow (PbSnO₄ or Pb(Sn,Si)O₃), Titanium Yellow (PY53), Mosaic gold (SnS₂), Zinc Yellow (PY36) (ZnCrO₄), Cadmium Orange (PO20), Chrome Orange(PbCrO₄+PbO), Realgar (As₄S₄), Cadmium Red (PR108) (CdSe), Sanguine, Caput Mortuum, Indian Red, Venetian Red, Oxide Red (PR102), Red Ochre (PR102) (Fe₂O₃), Burnt Sienna (PBr7), Minium, Pb₃O₄, Vermilion (PR106), Mercuric sulfide (HgS), Clay earth pigments (naturally formed iron oxides), Raw Umber (PBr7) (Fe₂O₃+MnO₂+nH₂O+Si+AlO₃), Raw Sienna (PBr7), Carbon Black (PBk7), Ivory Black (PBk9), Vine Black (PBk8)k, Lamp Black (PBk6), Mars Black (Iron black) (PBk11), Manganese dioxide (MnO₂), Titanium Black (Ti₂O₃), Antimony White (Sb₂O₃), Barium sulfate (PW5) (BaSO₄), Lithopone (BaSO₄*ZnS), Cremnitz White (PW1) ((PbCO₃)₂.Pb(OH)₂), Titanium White (PW6) (TiO₂), Zinc White (PW4) (ZnO), and any combination thereof.

It is further a scope of the present invention to provide any of the methods above, where said surfactant is selected from the group consisting of: SDS, CTAB, Triton X-100, X-114, CHAPS, DOC, NP-40, octyl thioglucoside, octyl glucoside, dodecyl maltoside, Nonoxynol-9, Polysorbate, Span, Poloxamers, Tergitol, Antarox, PENTEX 99, PFOS, Calsoft, Texapon, Darvan, Sodium stearate, and any combination thereof.

It is further a scope of the present invention to provide any of the methods above, where said polymer is selected from the group consisting of: Biopolymer, Inorganic polymer, Organic polymer, Conductive polymer, Copolymer, Fluoropolymer, Gutta-percha (Polyterpene), Phenolic resin, Polyanhydrides, Polyketone, Polyester, Polyolefin (Polyalkene), Rubber, Silicone, Silicone rubber, Superabsorbent polymer, Synthetic rubber, Vinyl polymer, and any combination thereof.

It is further a scope of the present invention to provide any of the methods above, where said polymer is selected from the group consisting of: Poly(ethylene glycol) (PEG), Polyvinyl pyrrolidone (PVP), Polyvinyl alcohol (PVA), Polyacrylic acid (PAA), Polyacrylamide, N-(2-Hydroxypropyl) methacrylamide (HPMA), Divinyl Ether-Maleic Anhydride (DIVEMA), Polyoxazoline, Polyphosphoesters (PPE), Polyphosphazenes, Xanthan Gum, Pectins, Chitosan Derivatives, Dextran, Carrageenan, Guar Gum, Cellulose Ethers (i.e.: Hydroxypropylmethyl cellulose (HPMC), Hydroxypropyl cellulose (HPC), Hydroxyethyl cellulose (HEC), Sodium carboxy methyl cellulose (Na-CMC)), Hyaluronic acid (HA), and any combination thereof.

It is further a scope of the present invention to provide any of the methods above, where said polymer is characterized by a molecular weight that is from about 10 kD to about 1300 kD.

It is further a scope of the present invention to provide any of the methods above, where said step of mixing is performed in a mixer selected from the group consisting of: magnetic stirrers, static mixers, multi-shaft mixers, continuous mixers, continuous processor, turbines, close-clearance mixers, high shear dispersers, liquid whistles, MIX-ITOMETER, ribbon blender, V blender, cone screw blender, screw blender, double cone blender, double planetary, high viscosity mixer, counter-rotating, double & triple shaft, vacuum mixer, high shear rotor stator, impinging mixer, dispersion mixers, paddle, jet mixer, mobile mixers, drum blenders, intermix mixer, horizontal mixer, hot/cold mixing combination, vertical mixer, turbomixer, planetary mixer, banbury mixer, and any combination thereof.

It is further a scope of the present invention to provide any of the methods above, where said step of mixing is performed for a period of time from about 1 hour to about 36 hours.

It is further a scope of the present invention to provide any of the methods above, where said step of mixing is performed at a temperature from about 4 degrees Celsius to about 40 degrees Celsius.

It is further a scope of the present invention to provide any of the methods above, where said disrupting step is performed by means of sonication, bead methods, centrifugal forces, compressed air, sonic waves, ultrasound, vibrations, electrostatics, and any combination thereof.

It is further a scope of the present invention to provide any of the methods above, where said disrupting step is performed for a period of time from about 10 minutes to about 120 minutes.

It is further a scope of the present invention to provide any of the methods above, where said step of centrifuging is performed by means selected from the group consisting of: fixed-angle centrifuge, swinging head centrifuge, continuous tubular centrifuge, clinical centrifuges, super-speed centrifuges, preparative ultracentrifuges, analytical ultracentrifuges, gas centrifuges, screen/scroll centrifuges, pusher centrifuges, peeler centrifuges, inverting filter centrifuges, sliding discharge centrifuges, pendulum centrifuges, separator centrifuges, solid bowl centrifuges, conical plate centrifuges, tubular centrifuges, decanter centrifuges, and any combination thereof.

It is further a scope of the present invention to provide any of the methods above, where said step of centrifuging is performed for a period of time from about 10 minutes to about 120 minutes.

It is further a scope of the present invention to provide any of the methods above, where said step of centrifuging is performed at a temperature from about 4 degrees Celsius to about 40 degrees Celsius.

It is further a scope of the present invention to provide any of the methods above, where said step of centrifuging is performed at a velocity from about 10,000 to about 16,000 rpm.

It is further a scope of the present invention to provide any of the methods above, where said drying step is performed by means selected from the group consisting of vacuum drier, hot air oven, and any combination thereof.

It is further a scope of the present invention to provide any of the methods above, where said drying step is performed at a temperature from about 30 degrees Celsius to about 100 degrees Celsius.

It is further a scope of the present invention to provide any of the methods above, where said drying step is performed for a period of time from about 10 minutes to about 36 hours.

It is further a scope of the present invention to provide any of the methods above, where said pulverizing step is performed by means selected from the group consisting of: mortar and pestle, pulverizer, grinder, and any combination thereof.

It is further a scope of the present invention to provide any of the methods above, where said pulverizing step produce particles having a size from about 300 nm to about 1500 nm.

### BRIEF DESCRIPTION OF THE DRAWINGS

The invention will now be described with reference to the drawings, wherein:

FIG. 1 presents a flow chart showing schematically one embodiment of the method of preparation of inorganic dye for use in a liquid crystal device according to the present invention;

FIG. 2 presents a flow chart showing schematically a second embodiment of the method of preparation of inorganic dye for use in a liquid crystal device according to the present invention; and,

FIG. 3 discloses a schematic illustration of the process used to perform the method of preparation of inorganic dye for use in a liquid crystal device according to the present invention.

### DETAILED DESCRIPTION OF THE PREFERRED EMBODIMENTS

The following description is provided so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a novel method of manufacture of inorganic pigments suitable for use in liquid crystal devices, particularly devices that comprise liquid crystal films, and methods of manufacture of liquid crystal devices that incorporate the inorganic pigments made by the inventive method. In some cases, for clarity or conciseness, individual elements, individual method steps, specific combinations of elements, and specific combinations of method steps are described. Nonetheless, any combination of disclosed elements or of method steps that is not self-contradictory is considered by the inventors to be within the scope of the invention.

As used herein, the abbreviation “LC” stands for “liquid crystal” and the abbreviation “PDLC” for “polymer dispersed liquid crystal.”

As used herein, the term “coating precursor” refers to any substance that can provide a coating in situ for particles suspended or dispersed in a liquid, whether by direct deposition from solution or dispersion, or by chemical reaction to form the substance that coats the particles.

With respect to a transparent, translucent or semi-translucent object, the term “haze (H)” as used herein refers hereinafter to the quantity defined by eq (1)

$$H = 100 ( \frac{{I}_{s > 2.5}}{{I}_{0}} ) \qquad ( 1 )$$

where I_{s>2.5} is the intensity of light scattered through an angle greater than 2.5° with respect to the direction of the incident light, and I₀ is the total intensity of the incident light.

As used herein, the term “total transmittance (T₁)” refers to the quantity defined by eq (2)

$${T}_{t} = 100 ( \frac{{I}_{t}}{{I}_{0}} ) \qquad ( 2 )$$

where Iₜ is the total intensity of transmitted light (i.e. integrated over all scattering angles).

As used herein, the term “direct transmittance (T_{d})” refers to the portion of the transmitted light that passes through an object with a scattering angle of less than 2.5° with respect to the direction of the incident light.

As used herein, the term “retrofit(ting)” refers to the modification of a conventional window or surface by combining the same in some manner with an enhancement, i.e., a switchable glazing, non-switchable light modulating device, etc.

As used herein, the term “dye” refers to a soluble substance that provides color to a substrate, and the term “pigment” to an insoluble substance that provides color to a substrate.

As used herein, the term “carbon black” refers to a black pigment comprising a particulate form of paracrystalline carbon. The term is used to refer to all such pigments, which are generally produced by incomplete combustion of petroleum products. Acetylene black, channel black, furnace black, lamp black, and thermal black are non-limiting examples of pigments that are described by the term “carbon black” as used herein.

As used herein, the term “nanoparticle” refers to a particle with a characteristic dimension (e.g. mean diameter) of 0.1-100 nm, and “nanoparticulate” to a substance made up of nanoparticles.

As used herein the term “microparticle” refers to a particle with a characteristic dimension of greater than 0.1 μm and less than 100 μm, and “microparticulate” to a substance made up of microparticles.

As used herein, the terms “suspension” and “dispersion” are both used to refer to a system in which particles of a solid are dispersed in a liquid in which the solid is not soluble. While “suspension” generally refers to a system in which the solid particles are sufficiently large for sedimentation to take place (e.g., a system in which the insoluble solid comprises microparticles) “dispersion” to a system in which the solid particles are not sufficiently large to take place (e.g. a system such as a colloidal dispersion in which the insoluble solid comprises nanoparticles), unless specifically stated otherwise, as used herein, the terms are used interchangeably, and unless the particle size is specified, a the use of either of the terms with reference to a process or process step involving creation or treatment of a suspension or dispersion does not place any limitation on the sizes of individual particles in the system.

As used herein, with respect to a suspension or dispersion of insoluble particles in a liquid, the term “disrupting” is used to refer to any process that will reduce the size and/or number of agglomerates of particles in the suspension or dispersion.

As used herein, with reference to numerical quantities, the term “about” refers to a range of values ±25% of the nominal value.

In order for a pigment to be suitable for use in a liquid crystal device, particularly devices such as smart windows or displays based on PDLC films, it must have several important characteristics. First, the particles must be sufficiently small such that the final composition will have a low haze when the device is in its transparent state, preferably not more than 7%. Second, if the particles are to be incorporated into the liquid crystal layer, they must have a low conductivity in order that the device not short-circuit when a voltage is applied across the liquid crystal. On the other hand, the particles must have an albedo sufficiently low that the total transmittance of the device in its translucent state is low, preferably not more than 55%, more preferably not more than 30%, yet more preferably not more than 20%, even yet more preferably not more than 10%, and most preferably not more than 5%. Carbon black comprises small particles and has a low albedo, but commercially available carbon black is in general not appropriate for use in liquid crystal devices. First, although commercially available carbon black is generally nanoparticulate, off-the-shelf carbon black tends to have significant numbers of agglomerates of particles; these agglomerates are much too large for use as pigments in liquid crystal devices. Moreover, carbon black is conductive, and thus cannot be introduced as-is into liquid crystal devices.

Thus, any method of preparation of a pigment based on carbon black for use in liquid crystal devices must necessarily include a way of breaking up the agglomerates into individual nanoparticles and a way of reducing or eliminating its conductivity. As described below, in preferred embodiments of the invention disclosed herein, the agglomerates are broken up by physical disruption of a dispersion or suspension of the particles in a solvent, and the reduction of conductivity is accomplished by coating the pigment particles with a non-conductive coating such as a non-conductive polymer or metal oxide.

In order for a device incorporating pigment particles to have an acceptably low haze, not only must the pigment particles be small (preferably nanoparticles), but the optical properties of the polymer with which they are coated must be chosen to be appropriate for use with the particular liquid crystal being used in the device. In particular, the polymer should preferably be chosen such that the polymer-coated pigment particles will match as well as possible the refractive index of the liquid crystal when the liquid crystal composition is prepared.

The inventors have found a method for preparing inorganic pigments based on materials such as carbon black that yields pigment particles that meet all of the criteria for suitability given above. The particles produced by the inventive method are small, have low conductivity, and are refractive index matched to be usable in liquid crystal devices such as smart windows and display screens that are based on PDLC films. The haze of the devices that incorporate particles manufactured by the inventive method is typically less than 7%.

While these characteristics are suitable for some applications, using conductive pigments in liquid crystal devices is challenging, also because of their electric conductivity.

In order to use a conductive pigment in a LC device, there are two main options: either separate the pigment from the LC dispersion; or neutralize the electric conductive properties of the conductive pigments, therefore allowing the insertion of the dye inside the LC dispersion.

The present invention provides a novel method of manufacturing a conductive pigment dye that is suitable to be included in the LC dispersion.

PDLC films, which are composed of LC microdroplets dispersed in a polymer matrix, have been the subject of much academic and industrial research. These electro-optical systems can be switched by applying an electric field from a scattering field-off state to a transparent field-on state. This property can be used to construct devices with electrically modulated light and visual transmission for applications in large-area architectural glazing. A good product for these applications should have high opacity in the field-off state and high transparency over a wide viewing angle (low haze) in the field-on state. The phenomenon of haze in the field-on state of a PDLC arises from the residual refractive index difference between the polymer matrix and the aligned LC in the droplets. It is necessary to distinguish between “normal” haze measured in a direction perpendicular to the film plane and “off-axis” haze measured at other viewing angles. These values depend on various PDLC material and processing parameters.

The insertion of any material in the LC dispersion causes a natural increase in the haze due to an increase refractive index difference caused by the new material in the polymer matrix.

Micro-sized particles cause an increase in haze due to the scattering of the wavelength in the visible range.

It is a scope of the present invention to provide a novel method for producing an inorganic pigment that is suitable to be included in the LC dispersion, particularly in that inclusion of the pigment in the dispersion leads to a device with a haze level that is not perceivably different to the naked eye from a LC film without the pigment.

In one embodiment of the present invention, the methodology used is a process of isolation and precipitation of the conductive pigments or in other words, on solvent/antisolvent precipitation techniques.

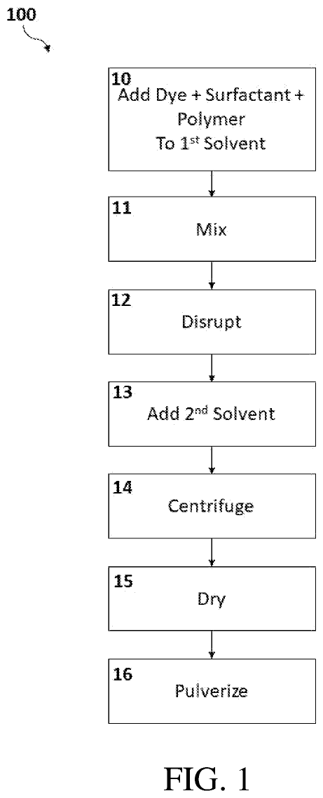

Reference is now made to FIG. 1, which presents a schematic flowchart of one non-limiting embodiment of the method 100 disclosed herein for producing coated pigment particles, in which particles of a pigment are coated with a polymer. The general description of the method 100 given here is followed by a more detailed description of specific method steps. In one non-limiting exemplary embodiment, the method begins by preparing a solution of a surfactant and a polymer in a first solvent and then adding particles of a pigment, typically an electrically conductive pigment such as carbon black, to the solution (step 10 in the flowchart). In these embodiments, the polymer serves as the coating precursor. Any solvent in which the polymer and surfactant are soluble may be used; in typical applications, the first solvent is water. In some embodiments of the invention, rather than adding pigment particles to a surfactant/polymer solution, the pigment particles, surfactant, and polymer are added to the solvent together in a single step. The solution and pigment particles (or, in embodiments in which the surfactant and polymer are added with the pigment particles, all of the components) are then mixed (step 11) until a homogeneous suspension or dispersion of the pigment is obtained. In general, suspension or dispersion will include agglomerates that are too large to be suitable for use in a LC application because their incorporation “as is” into the device would lead to a haze level too high to be useful. Therefore, a step of disruption (12) is performed in order to reduce the size of the agglomerates in the suspension, preferably breaking them up into isolated single particles in dispersion; methods of performing this step are described in detail below.

The step of disruption is followed by addition of a second solvent that can act as an antisolvent for the polymer in the solution (step 13). The second solvent must be one that is miscible with the first solvent, but in which the polymer is significantly less soluble than it is in the first solvent. In preferred embodiments, the second solvent is chosen to be one in which the polymer is insoluble; in embodiments of the invention in which the first solvent is water, the second solvent is typically acetone. Upon addition of the second solvent, the polymer precipitates from the solution onto the surface of the pigment particles, thereby coating them, significantly lowering their electrical conductivity, and preferably rendering them non-conductive.

The step of adding a second solvent is followed by a step (14) of separating the coated particles from the dispersion. The separation is typically performed by centrifugation. In preferred embodiments of the invention, any particles or agglomerates remaining that are too large for use in the LC device are removed following the separation. In some embodiments of the invention, the coated particles are washed (typically with the second solvent) in order to remove first solvent from the wet particles.

In typical embodiments of the method, the coated particles that have been separated from the suspension or dispersion are then dried (step 15) in order to evaporate remaining solvent, leaving only the isolated non-conductive pigment. In typical embodiments, the particles tend to adhere to each other during the drying process, leading to formation of chunks and blocks of material. In order to put it in a form that is usable for introduction into LC devices, the dried material is then reduced to a powder (step 16), typically by pulverization, yielding freely flowing particles (typically comprising nanoparticles) that are suitable in all respects for, and easily usable in, LC applications.

In typical embodiments of the invention, in the first step of the process, surfactant and polymer are added to a suitable first solvent. In some preferred embodiments of the invention, the first solvent is water. Since, as explained above, the second solvent added at a later stage should be miscible with the first solvent but one in which the polymer is insoluble or sparingly soluble, the choice of first solvent will limit the choice of possible second solvent.

Non-limiting examples of solvents that can be used in the method herein disclosed include hexane, benzene, toluene, diethyl ether, chloroform, 1,4-dioxane, ethyl acetate, tetrahydrofuran, dichloromethane, acetone, acetonitrile, dimethylformamide, dimethyl sulfoxide, acetic acid, n-butanol, isopropanol, n-propanol, ethanol, methanol, formic acid, and water, with the limitation that the two solvents must be miscible, and the polymer coating must be significantly less soluble in the second solvent than it is in the first solvent.

Non-limiting examples of surfactants that can be used in the method herein disclosed include SDS, CTAB, Triton X-100, X-114, CHAPS, DOC, NP-40, octyl thioglucoside, octyl glucoside, dodecyl maltoside, nonoxynol-9, polysorbate, span, poloxamers, Tergitol, Antarox, PENTEX 99, PFOS, Calsoft, Texapon, Darvan, and sodium stearate.

The polymer with which the particles are to be coated is preferably chosen such that it will be soluble in the LC medium to be used in the LC device, and that the polymer-coated particles will match the index of refraction of the LC medium. In particularly preferred embodiments, especially those in which the LC device includes a PDLC layer, the polymer comprises a hydrophobic chain with hydrophilic side groups.

Any polymer known in the art that meets the physical, optical, and chemical criteria for use as a coating for particles to be incorporated in a LC device may be used. Non-limiting examples of suitable polymers include poly(ethylene glycol) (PEG); polyvinylpyrrolidone (PVP); hyaluronic acid; polyvinyl alcohol (PVA); polyacrylic acid (PAA); polyacrylamide; N-(2-Hydroxypropyl) methacrylamide (HPMA); divinyl ether-maleic anhydride (DIVEMA); polyoxazoline; polyphosphoesters (PPE); polyphosphazenes; xanthan gum; pectin; chitosan; chitosan derivatives; dextran; carrageenan; guar gum; and cellulose ethers such as hydroxypropylmethyl cellulose (HPMC), hydroxypropyl cellulose (HPC), hydroxyethyl cellulose (HEC), and sodium carboxy methyl cellulose (Na-CMC). In preferred embodiments of the invention, PVP is used.

The inventors have found that the molecular weight of the polymer can in some affect the usefulness of the final product. For example, while short-chain PVP dissolves in PDLCs, long-chain PVP does not, which means that for PDLC applications, the chain length of the PVP is a parameter of interest. Thus, in some embodiments of the present invention the polymer is characterized by a molecular weight of from about 10 kD to about 1300 kD.

In the second step of the process herein disclosed, particles of pigment are added to the solvent. In some embodiments of the invention, the particles of pigment are added to the solvent along with the surfactant and polymer. In preferred embodiments of the invention, the pigment particles are added only after a homogeneous solution of surfactant and polymer in the solvent has been prepared. Non-limiting examples of pigments that can be used in the process herein disclosed include carbon black, silver, boron carbide, titanium nitride, zirconium carbide, zirconium boride, tungsten carbide, and tungsten disulfide.

A variety of dyes can be used in order to confer a specific color to a LC film. While the scope of this invention is the manufacture of suitable black pigments, other colors can be prepared using the methods disclosed herein.

Dyes are classified according to their solubility and chemical properties, whether they are organic or inorganic, natural or synthetic.

In several embodiments of the present invention the organic dyes are selected from the group consisting of: Alizarin, Anthoxanthin, Arylide yellow, Azo compound, Bilin (biochemistry), Bistre, Bone char, Caput mortuum, Carmine, Crimson, Diarylide pigment, Dibromoanthanthrone, Dragon's blood, Gamboge, Indian yellow, Indigo dye, Naphthol AS, Naphthol Red, Ommochrome, Perinone, Phthalocyanine Blue BN, Phthalocyanine Green G, Pigment violet 23, Pigment Yellow 10, Pigment Yellow 16, Pigment Yellow 81, Pigment yellow 83, Pigment yellow 139, Pigment yellow 185, Quinacridone, Rose madder, Rylene dye, Sepia (color), Tyrian purple, and any combination thereof.

In several embodiments of the present invention the inorganic dye or pigment is selected from the group consisting of: Ultramarine violet: (PV15) Silicate of sodium and aluminum containing sulfur, Han Purple: BaCuSi₂O₆, Cobalt Violet: (PV14) cobaltous orthophosphate, Manganese violet: NH₄MnP₂O₇ (PV16) Manganic ammonium pyrophosphate, Ultramarine (Na₈₋₁₀ Al₆Si₆O₂₄S₂₋₄), Persian blue, (Na,Ca)₈(AlSiO₄)₆(S,SO₄,Cl)₁₋₂, Cobalt Blue (PB28), Cerulean Blue (PB35), Egyptian Blue (CaCuSi₄O₁₀), Han Blue: BaCuSi₄O₁₀, cupric carbonate hydroxide (Cu₃(CO₃)₂(OH)₂), Prussian Blue (PB27) (Fe7(CN)18), YInMn Blue (YIn₁₋ₓMnₓO₃), Cadmium Green, Chrome green (PG17 (Cr₂O₃), Viridian (PG18) (Cr₂O₃.H₂O), Cobalt green (CoZnO₂), Malachite (Cu₂CO₃(OH)₂), Paris Green (Cu(C₂H₃O₂)₂.3Cu(AsO₂)₂), Scheele's Green (CuHAsO₃), Verdigris (Cu(CH₃CO₂)₂), malachite (Cu₂CO₃(OH)₂), Green earth (K[Al,Fe^{III}),(Fe^{II},Mg](AlSi₃,Si₄)O₁₀(OH)₂), Orpiment (As₂S₃), Cadmium Yellow (PY37), Chrome Yellow (PY34) (PbCrO4), Aureolin (PY40): Potassium cobaltinitrite (K₃Co(NO₂)₆), Yellow Ochre (PY43) (Fe₂O₃.H₂O), Naples Yellow (PY41), Lead-tin-yellow (PbSnO₄ or Pb(Sn,Si)O₃), Titanium Yellow (PY53), Mosaic gold (SnS₂), Zinc Yellow (PY36) (ZnCrO₄), Cadmium Orange (PO20), Chrome Orange(PbCrO₄+PbO), Realgar (As₄S₄), Cadmium Red (PR108) (CdSe), Sanguine, Caput Mortuum, Indian Red, Venetian Red, Oxide Red (PR102), Red Ochre (PR102) (Fe₂O₃), Burnt Sienna (PBr7), Minium, Pb₃O₄, Vermilion (PR106), Mercuric sulfide (HgS), Clay earth pigments (naturally formed iron oxides), Raw Umber (PBr7) (Fe₂O₃+MnO₂+nH₂O+Si+AlO₃), Raw Sienna (PBr7), Carbon Black (PBk7), Ivory Black (PBk9), Vine Black (PBk8)k, Lamp Black (PBk6), Mars Black (Iron black) (PBk11), Manganese dioxide (MnO₂), Titanium Black (Ti₂O₃), Antimony White (Sb₂O₃), Barium sulfate (PW5) (BaSO₄), Lithopone (BaSO₄*ZnS), Cremnitz White (PW1) ((PbCO₃)₂.Pb(OH)₂), Titanium White (PW6) (TiO₂), Zinc White (PW4) (ZnO), and any combination thereof.

After the components are added to the solvent, they are mixed until a homogeneous suspension or dispersion of the pigment particles in the surfactant/polymer solution is obtained.

Any suitable method of mixing known in the art may be used. Non-limiting examples of types of mixers that can be used include Ribbon Blender, V Blender, Continuous Processor, Cone Screw Blender, Screw Blender, Double Cone Blender, Double Planetary, High Viscosity Mixer, Counter-rotating, Double & Triple Shaft, Vacuum Mixer, High Shear Rotor Stator, Impinging mixer, Dispersion Mixers, Paddle, Jet Mixer, Mobile Mixers, Drum Blenders, Intermix mixer, Horizontal Mixer, Hot/Cold mixing combination, Vertical mixer, Turbomixer, Planetary mixer, and Banbury mixer.

As was explained above, in general, commercially available pigments such as carbon black comprise particles that are either too large to be useful in LC applications, or are present in the form of agglomerates that cannot be used until and unless the particles are separated. Thus, a step of reducing the size of agglomerates and separating the particles that form them is necessary to obtain suitable pigment particles. In preferred embodiments of the invention, this step is performed after the suspension or dispersion of pigment particles in the surfactant/polymer solution has been prepared. The particles are reduced by “disrupting” the solution via an energy input sufficiently strong to break up the agglomerates into particles that are small enough to be suitable; in preferred embodiments of the invention, the agglomerate size is reduced at this stage to yield a nanoparticulate material with particles characterized by sizes of ≤100 nm as measured by dynamic light scattering. Typical particle sizes to which the particles are reduced in the cases of the pigments listed above are silver, 80 nm; boron carbide, 60 nm; titanium nitride, 40 nm; zirconium carbide, 30 nm; zirconium boride, 50 nm; tungsten carbide, 80 nm; and tungsten disulfide, 60 nm.

Any appropriate method of disrupting the solution that will reduce the particle size sufficiently may be used. In preferred embodiments of the invention, the step of reducing the particle size is performed by sonication or ultrasonication of the suspension, typically at frequencies of >20 kHz.

In some embodiments of the invention, the particle size is reduced by use of the well-known technique of bead beating. In this method, small inert beads made of a sufficiently hard substance (e.g. glass, ceramic, or steel) are mixed with the suspension and then agitated, e.g. by stirring or shaking. The collisions between the beads and the suspended particles cause the particles to break up into particles of smaller size. Bead beating has several advantages. For example, it can be used to disrupt very small sample sizes, process many samples at a time with no cross-contamination concerns, does not release potentially harmful aerosols in the process, provides moderate mechanical shear during the process. Any appropriate bead beating apparatus known in the art may be used. In typical embodiments of the inventive method in which bead beating is used, a volume of beads equal to that of the suspension is added to and the sample is vigorously mixed on a common laboratory vortex mixer. Specialized shaking machines can be used to lower the process time. Such shaking machines can agitate the sample at about 2000 oscillations per minute, and material disruption is complete in 1-3 minutes of shaking.

After the disruption of the suspension or dispersion to produce separated particles, in some embodiments of the invention, the particles are then coated with polymer. The coating is preferably accomplished by addition of a second solvent. The technique is that of the use of antisolvent which is well-known as a method of crystallization. In the method herein disclosed, a second solvent is added that is miscible with the first solvent but in which the polymer is much less soluble; in preferred embodiments, the polymer is sparingly soluble or insoluble in the second solvent. As a non-limiting example, in embodiments in which the first solvent is water, the second solvent is typically acetone. The addition of the second solvent causes the polymer to precipitate from solution (not necessarily as crystals) and to coat the surface of the particles suspended therein. As explained above, the polymer coating provides the optical and electrical properties that make the pigment particles suitable for use in LC applications.

Following the step of adding the second solvent and thereby coating the particles, the coated particles are then separated from the liquid. Because of their small size, the natural settling time is far too long for separation by settling to be efficient, and so in preferred embodiments of the invention, the separation is performed by centrifugation. Any type of centrifuge known in the art that is appropriate for separating the coated particles from the liquid may be used. The supernatant liquid can then be poured off, leaving the separated particles behind.

In some embodiments of the invention, the separated particles are washed in order to remove excess solvent and polymer. As a non-limiting example, they can be washed with the second solvent to remove the first solvent. In cases in which the second solvent is significantly more volatile than the first solvent such as the example of water and acetone given above, the washing both removes the first solvent and makes subsequent drying easier.

Following the separation and optional washing, in preferred embodiments of the invention, the particles are then dried. Any technique that is known in the art that is appropriate for drying the particles may be used. Non-limiting examples include vacuum drying and hot air drying. In typical embodiments of the invention, the drying is performed in the vessel in which the separation took place (e.g. the centrifuge tube in embodiments in which the separation was effected by centrifugation).

The particles that are produced by the steps listed thus far typically dry into blocks or lumps in which the particles adhere to one another. Since the particles need to be dispersed when they are used in the LC composition, the step of drying the particles is typically followed by a step of reducing the dried particle composition to a powder. Any appropriate technique for reducing the particles to a nanoparticulate powder may be used. Non-limiting examples include pulverization (e.g. using a mortar and pestle or a mechanical pulverizer such as a pulverizer mill) and grinding.

The powder comprising polymer-coated pigment particles can then be stored for use in a LC device.

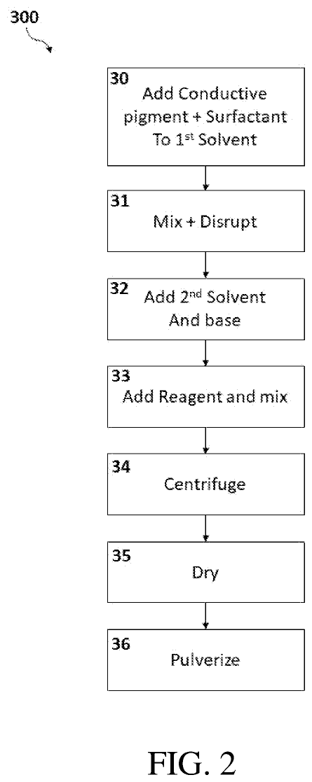

In some non-limiting embodiments of the invention, rather than a polymer, the non-conductive coating comprises a metal oxide. In these embodiments, the coated particles are prepared by a sol-gel process. Reference is now made to FIG. 2, which shows a schematic flow chart of a non-limiting embodiment 300 of the method of the present invention, in which the coating of the pigment particles is achieved via a process similar to sol-gel processes known in the art. The method 300 begins by adding the pigment particles and a surfactant to a first suitable solvent (step 30) to form a suspension or dispersion, which is then disrupted (step 31) to reduce the particle size and separate agglomerated particles. Next, a second suitable solvent and a base are added to the solution (step 32). As a non-limiting example, if the first solvent is water, then the second solvent can be ethanol and the base ammonium hydroxide. In the next step 33, suitable sol-gel reagent such as an alkoxide is added to the dispersion or suspension as the coating precursor, and the dispersion or suspension mixed. Non-limiting examples of suitable sol-gel reagents include tetraethoxysilane, titanium tetraisopropoxide, titanium tetrabutoxide, titanium ethoxide, and zirconium propoxide. The basic conditions cause hydrolysis of the sol-gel reagent to yield a metal oxide, which is deposited on the pigment particles, thereby producing a non-conductive oxide coating. Centrifugation is then performed (step 34) in order to separate the coated pigment particles from the supernatant liquid. The separated particles are then dried (step 35) and the material reduced to a powder (step 36) comprising non-conductive pigment particles that can be stored for use in LC applications.

The following non-limiting examples are provided in order to assist a person of ordinary skill in the art to make and use the instant invention.

### Example 1

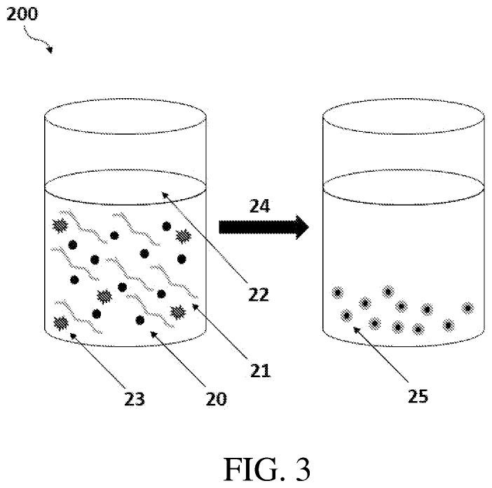

Reference is now made to FIG. 3, which shows a schematic illustration of the general principles of one non-limiting embodiment of the present invention (200).

In typical embodiments of the invention, from about 0.1 g to about 1 g of polymer and from about 0.1 ml to about 1.0 ml of surfactant are added to 100-500 ml of the first solvent. After complete dissolution of the polymer and surfactant, from about 0.1 g to about 1.0 g of conductive pigment are added. The suspension is stirred for from about 1 hour to about 6 hours at room temperature and then placed into ultrasound bath for from about 10 minutes to about 120 minutes, followed by stirred overnight on a stirring plate at room temperature. In typical embodiments, the particle size is then reduced by using a probe sonicator (e.g. SONICS, 750W, amplitude from about 10% to about 60%, from about 10 kHz to about 75 kHz) for about 10 minutes to about 60 min. From about 100 ml to about 600 ml of the second solvent is then added to a container holding about 50 ml to about 250 ml of the suspension with continuous stirring. The nanoparticulate suspension is then stirred for from about 10 min to about 90 minutes, and the particles thereby obtained purified via washing centrifugation cycles in a centrifuge. The particles are typically dried overnight in a vacuum oven (typically at a pressure of 60 mm Hg and a temperature of 35-60° C., and the dried particles pulverized to yield a powder.

### Example 2

As an example of a second non-limiting embodiment of the invention, non-conductive pigment particles were prepared by a process of condensation of silicon compounds on the surface of the conductive pigments using silica/sol-gel modification techniques.

A surfactant (tryton X) was dissolved in water. Carbon black powder was added to the solution and the resulting suspension was disrupted by sonication. Next, ethanol and NH₄OH were added. Finally, an alkoxide (in different samples, titanium or silicate) was added and the resulting mixture stirred for 24 hours, thereby producing oxide-coated carbon black particles. The particles were separated from the supernatant liquid by centrifugation and dried in a vacuum oven.

### Example 3

PVP was completely dissolved in water, then particles of conductive pigment was added. The solution was stirred during 24 hours. The solution was then filtered and resuspended in ammonia in ethanol, then thoroughly mixed. Then the reagent was added under stirring. Finally, the solution was centrifugated and dried. The pellet was then crushed to create a powder.

### Example 4

The following example demonstrates usefulness of polymer coated pigment particles prepared according to the method disclosed herein in a LC device.

Samples of carbon black were obtained from two different commercial suppliers, and for each of the two samples, a powder comprising non-conductive pigment particles coated with PVP was prepared according to the method disclosed herein.

LC devices incorporated the coated particles were then prepared according to literature methods. A mixture of LC, polymer-coated carbon black particles (0.5% by weight), and a prepolymer was prepared. The prepolymer was then polymerized under photolysis to produce a PDLC composition containing polymer-coated carbon black particles. Properties of the pigment particles and LC devices containing them are summarized in Table 1, where “A” and “B” refer to the respective powders made from the two samples of carbon black; Tₒₙ=total transmittance when the device is in its transparent state; Hₒₙ=haze when the device is in its transparent state; Tₘᵢₙ=direct transmittance when the device is in its translucent state; Tₘₐₓ=direct transmittance when the device is in its transparent state; and V₉₀=voltage required to obtain 90% of Tₒₙ.

TABLE 1

| Sample | Size after sonication, nm | Tₒₙ | Hₒₙ | Tₘᵢₙ | Tₘₐₓ | V₉₀ |
|---|---|---|---|---|---|---|
| A | 102 ± 28.3 (98.5%), | 49.5 | 7.18 | 3.38 | 48.76 | 32.08 |
| | 5077 ± 561 (1.5%) | | | | | |
| B | 102 ± 28.3 (98.5%), | 60.6 | 6.82 | 3.44 | 59.04 | 32.97 |
| | 5077 ± 561 (1.5%) | | | | | |

In order to understand the source of haze formation, LC devices were prepared according to the same protocol but either without any pigment whatsoever or by incorporating 0.5% uncoated carbon black particles. The haze of the resulting devices was then measured. In the devices prepared without pigment, the haze was 2.5%. In the devices into which uncoated particles were incorporated, the haze was 3.4% (Tₒₙ=46%). That is, of the ˜7% haze in the devices containing polymer-coated pigment particles, about 1% of addition to haze value is due to scattering from the dye particles themselves, and about 3% due to the polymer coating or the morphology of the coated particles. Further reduction of the particle size could lead to additional reduction in haze.

1-54. (canceled)

55. A method for producing a coated pigment suitable for use in a liquid crystal device, wherein said method comprises:
preparing a first solution comprising a surfactant in a first solvent;
adding a coating precursor to said first solution;
adding a pigment comprising particles to said first solution;
mixing said pigment and said solution until a suspension or dispersion of said pigment in said first solution is obtained;
disrupting said suspension or dispersion, thereby separating agglomerates of said pigment into particles and producing a dispersion of said particles of pigment;
adding a second solvent miscible with said first solvent to said dispersion, thereby causing the deposition of a coating of material derived from said coating precursor onto a surface of at least a portion of said particles and producing coated particles;
separating at least a portion of said coated particles from said dispersion; and
reducing said coated particles separated from said dispersion to a powder.

56. The method according to claim 55, wherein said step of separating said coated particles from said suspension is followed by:
separating coated particles above a predetermined size from said coated particles;
discarding said coated particles above a predetermined size; and
retaining coated particles at or below said predetermined size.

57. The method according to claim 55, wherein said step of separating at least a portion of said coated particles from said dispersion comprises separating at least a portion of said coated particles from said dispersion to yield coated particles characterized by a diameter of ≤100 nm as measured by dynamic light scattering.

58. The method according to claim 55, wherein said step of separating at least a portion of said coated particles is followed by a step of washing said coated particles separated from said suspension.

59. The method according to claim 58, wherein said step of washing comprises washing with said second solvent.

60. The method according to claim 55, wherein said step of separating at least a portion of said coated particles from said suspension is followed by drying said coated particles separated from said suspension.

61. The method according to claim 55, wherein said step of adding particles of a pigment comprises adding particles of a conductive pigment.

62. The method according to claim 55, wherein said step of adding particles of a pigment comprises adding particles of at least one pigment selected from the group consisting of carbon black, silver, boron carbide, titanium nitride, zirconium carbide, zirconium boride, tungsten carbide, and tungsten disulfide.

63. The method according to claim 55, wherein said step of adding a coating precursor comprises adding a polymer that is less soluble in said second solvent than it is in said first solvent.

64. The method according to claim 63, wherein one of the following is true:
said first solvent is water;
said first solvent is water and said second solvent is acetone.

65. The method according to claim 63, wherein said polymer is selected from the group consisting of:
polymers comprising a hydrophobic chain and hydrophilic side groups;
polymers that are soluble in, and selected to match a refractive index of, a predetermined liquid crystal material; and
polymers characterized by a molecular weight of between 10 and 1300 kD; and,
any combination thereof.

66. The method according to claim 63, wherein said polymer is polyvinylpyrrolidine.

67. The method according to claim 63, wherein:
said steps of preparing a first solution comprising a surfactant in a first solvent and adding a coating precursor to said first solution are performed by preparing a first solution comprising a surfactant and a polymer; and
said step of adding a pigment comprises adding a pigment to said first solution comprising said surfactant and said polymer.

68. The method according to claim 55, wherein:
said step of adding a coating precursor comprises adding a sol-gel reagent that upon hydrolysis will yield a non-conductive oxide; and
said method comprises adding a reagent that will initiate hydrolysis of said sol-gel reagent.

69. The method according to claim 68, wherein a condition from the group consisting of:
said step of adding pigment precedes said step of adding a coating precursor; and
said steps of adding pigment and disrupting said suspension or dispersion precede said step of adding a coating precursor;
is true.

70. The method according to claim 68, wherein said steps of preparing a second solution and adding said second solution to said first solution precede said step of adding pigment.

71. A method for making a polymer dispersed liquid crystal (PDLC) composition comprising polymer-coated pigment particles, comprising:
preparing a homogeneous mixture comprising prepolymer, a liquid crystal, and coated pigment particles prepared according to the method according to claim 55; and
polymerizing said prepolymer to yield said PDLC composition.

72. The method according to claim 71, wherein said coated pigment particles are selected from the group consisting of:
particles comprising carbon black coated with PVP; and
particles comprising carbon black coated with a non-conductive metal oxide.

73. The method according to claim 71, wherein said step of preparing a homogeneous mixture comprises preparing a homogeneous mixture comprising between 0.3% and 1% by weight of polymer-coated pigment particles.

74. The method according to claim 71, wherein said polymer-coated pigment particles are characterized by a conductance sufficiently small so as to yield a PDLC composition characterized by a conductance of no greater than 10⁻¹² (ohm-cm)².
